(19) United States
(12) Patent Application Publication
(10) Pub. No.: US 2011/0184749 A1
(43) Pub. Date: Jul. 28, 2011

(54) COLLABORATION SYSTEM & METHOD FOR DOING BUSINESS

(76) Inventor: Ritchie Stevens, Park City, UT (US)

(21) Appl. No.: 12/694,094

(22) Filed: Jan. 26, 2010

(51) Int. Cl. G06Q 50/00; G06Q 90/00; G06Q 10/00

(52) U.S. Cl. 705/2; 705/500

(57) ABSTRACT

A medical collaboration method and a system supporting that method. The collaboration is between a diagnosing physician, a radiation physician and a third party provider. In some embodiments the method and system provide peer review, concurrence and coordinated planning and implementation of radiation treatment/therapy. The methodology of the collaboration can include mandatory steps, and sign-off approvals prior to proceeding, and policies and procedures to ensure cooperation. The system may include the creation, transmission of, and sharing of computer-based, digital files, and online collaboration tools.

### BACKGROUND

When a diagnosing physician discerns the presence of a cancer in a patient and the cancer is such that radiation treatment is the recommended intervention, the diagnosing physician refers the patient to a radiation oncologist, a radiation physician. The radiation physician examines the patient and if radiation treatment is indeed indicated, the radiation physician performs a series of examinations and tests; the results of which are then used by the radiation physician to create a radiation treatment plan (RTP).

Typically, the first of these tests is the Planning CT scan. The goal is to be able to accurately and precisely define the target area(s) for radiation treatment. To accomplish this, the contour of the cancer or “Gross Tumor Volume” (GTV) must be determined and drawn on each CT scan image. The adjacent organs at risk (OARs) are identified as well. All of this information is submitted to the physics division of the radiation treatment facility where calculations are then performed to develop the RTP.

This completed RTP is reviewed and approved by the radiation physician, and the insurance carrier is billed. The RTP is then tested with Quality Assurance procedures on the treatment equipment following which, the patient is brought in to begin receiving the radiation treatment itself. Once the course of radiation treatment is completed, the patient is then referred back to the diagnosing physician for follow-up examinations.

Throughout the completion of the RTP, the radiation physician and his/her staff work primarily on their own. There is no direct input into the development of the RTP by the diagnosing physician. The creation of the RTP and its subsequent implementation are performed essentially in isolation. External reviews either by the diagnosing physician or an independent third party are completely lacking.

### SUMMARY

Disclosed are embodiments of a method for business collaboration. In some embodiments the collaboration is between a diagnosing physician, a radiation physician and a third party provider in order to provide peer review, concurrence and coordinated planning and implementation of radiation treatment/therapy. The methodology of the collaboration can include mandatory steps, and sign-off approvals prior to proceeding, and policies and procedures that can, if desired, ensure not only cooperation, but also equitable compensation for all participants.

Advantages of such collaboration can include one or more among:
Better quality treatment due to better quality radiation treatment plans (RTPs).
Better quality RTPs due to:
   Mandatory Peer-Review for RTP,
   The participation of an Independent 3^{rd} Party who coordinates collaborative efforts and monitors RTP creation and quality.
Compensation, and hence motivation, for the diagnosing physician's participation in RTP development and influencing the planned course of treatment.

In some embodiments the collaboration is facilitated by the use of an online, integrated, interactive database and project management system. The advantages of such collaboration include:
Better quality RTPs due to the elimination of geographic proximity restrictions that prevent involved physicians (diagnosing and radiation) from working together.
More streamlined and accountable overall process due to the use of state of the art computer technology, state-of-the-art information storage and sharing.
Improved and faster communications between participating care providers
Improved accountability and improved audit and archive functionality for all relevant diagnostic and treatment data.
Improved information security.
Improved regulatory compliance through the adoption and use of the government's EMR initiatives.

It is to be understood that the foregoing is a brief summary of various aspects of some disclosed embodiments. The scope of the disclosure need not therefore include all such aspects or address or solve all issues noted in the background above. In addition, there are other aspects of the disclosed embodiments that will become apparent as the specification proceeds.

The foregoing and other features, utilities, and advantages of the subject matter described herein will be apparent from the following more particular description of certain embodiments as illustrated in the accompanying drawings. In this regard, it is to be understood that the scope of the invention is to be determined by the claims as issued and not by whether given subject includes any or all features or aspects noted in this Summary or addresses any issues noted in the Background.

### BRIEF DESCRIPTION OF THE DRAWINGS

The preferred and other embodiments are disclosed in association with the accompanying drawings in which:

FIG. 1 is a flow chart detailing the overall collaboration system detailed herein;

FIG. 2 is a flow chart detailing a preferred embodiment that utilizes digital media and online, interactive, collaboration.

### DETAILED DESCRIPTION

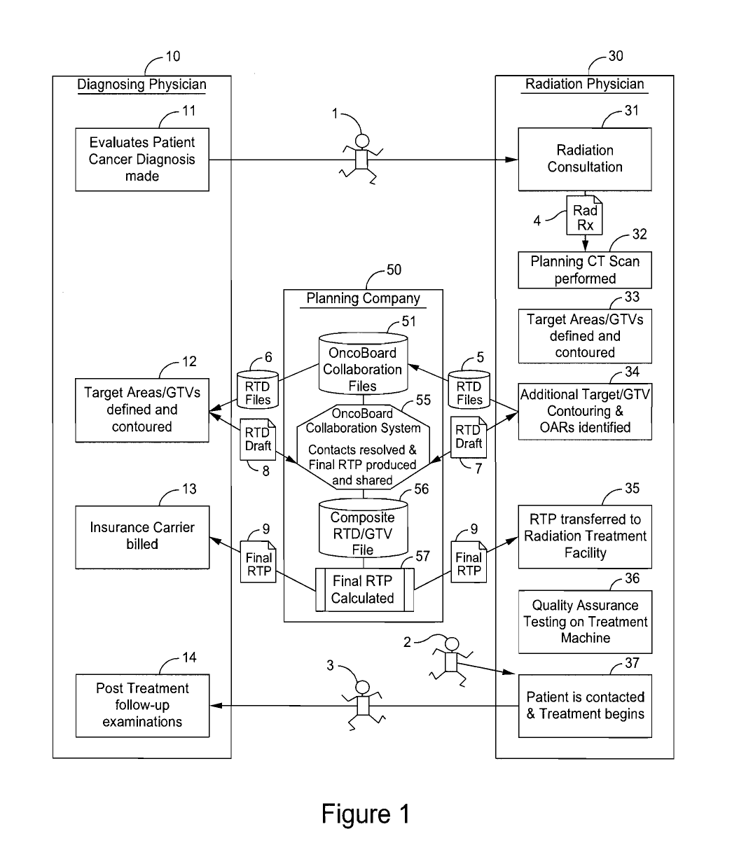

With reference to the embodiment of FIG. 1, three distinct logical entities that provide service and participate in this process: The diagnosing physician 10, the radiation physician 30, and the planning company 50. The process begins when the diagnosing physician 10 performs an evaluation and a cancer diagnosis is made 11. The patient 1 is then referred to the radiation physician 30 for a radiation consultation 31. If radiation is indicated, a radiation prescription is written 4.

To ultimately develop a radiation treatment plan (RTP) 9, additional tests are required. A planning CT scan 32 is performed. Using the CT scan images of the patient's body, the radiation physician 30 draws/contours the proposed target area(s) and in doing so, defines 33 the Gross Tumor Volume. Adjacent regions within the body to be protected from receiving too much radiation are also contoured; these are known as “organs at risk” (OARs). This information is refined and recorded 34 in the preliminary radiation treatment data (RTD) files 5. The RTD files 5 are then sent to the planning company 50 where they are centrally stored in the OncoBoard collaboration files 51.

The RTD files 5 are further processed by the planning company 50 and an adjusted RTD file 6, one in which the GTV contours defined by the radiation physician 30 are excluded, is forwarded for direct review by the diagnosing physician 10. The diagnosing physician 10 then makes a completely independent determination of what he/she believes the target area(s)/GTV to be, defining 12 them and their contours, and thereby creating a second, unique version of the radiation treatment data (RTD) files 8. This new RTD files 8 are then sent back to the planning company 50 for processing 55 and storage with the OncoBoard collaboration files 51.

In conjunction with the planning company 50, the GTV contours contained within the RTD files 5 previously created by the radiation physician 30 are then shared with the diagnosing physician and overlaid with RTD files 8 defined by the diagnosing physician 10. If these RTD files/GTV contours 5 and 8 match perfectly, the diagnosing physician 30 signs off on these matched GTV contours, now comprising a “composite” RTD/GTV file 56. This file is then submitted for physics and computer calculations 57, leading to the completion of the final Radiation Treatment Plan (RTP) 9. Conversely, if significant differences exist in the independently defined RTD files/GTV contours 5 and 8, both physicians, the radiation physician 30 and the diagnosing physician 10 will be contacted and through a coordinated exchange of information, including draft RTD files 7 and 8, the planning company 50 will facilitate a collaborative effort between the diagnosing 10 and radiation 30 physician to resolve differences and possible conflicts, producing a mutually agreed upon GTV and “composite” RTD/GTV file 56. As above, the composite RTD/GTV file 56 is then submitted for physics and computer calculations 57. In either scenario, the RTP 9 ultimately created will be the culmination of a cooperative effort between physicians from different medical disciplines through the iterative exchange of opinions and comments.

Once calculations are complete 56 and the RTP 9 is generated, it is sent to both the diagnosing physician 10 and the radiation physician 30. The former acknowledges the completion of the RTP 9 that has been contracted for and uses the information therein to bill 13 the insurance carrier. The latter shares the RTP 9 with the radiation treatment facility 35. Before treatment can commence, quality assurance testing is conducted 36 on the treatment machine.

When all is in readiness, the patient 2 is called in and, all under the supervision of the radiation physician 30, treatment begins 37.

After the prescribed treatments, as set forth in the RTP 9, are concluded, the patient 3 is referred back to the diagnosing physician 10 for post-treatment follow-up examinations 14.

The entire process is governed by a formal set of policies and procedures, requiring sign-offs and approvals before proceeding to subsequent steps.

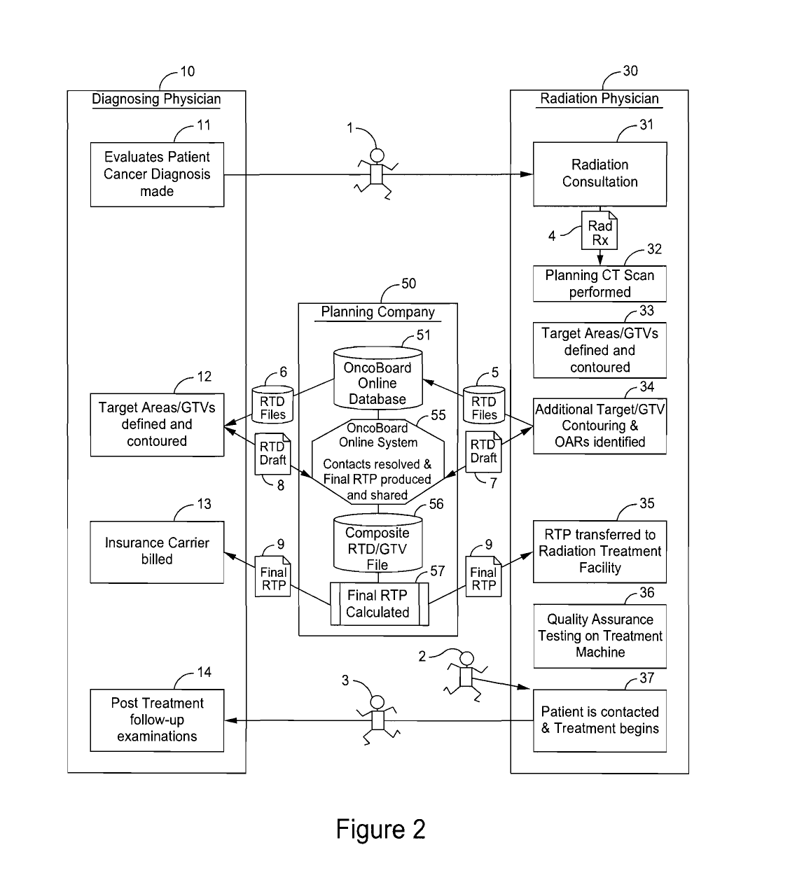

With reference now to FIG. 2, in an alternative or additional embodiment, the planning company 50's collaboration facilitation is via an online collaboration system 55, with a shared, online, interactive database, the OncoBoard database 51.

In this embodiment, after the radiation physician creates the RTD files 5, these are then sent to the planning company 50's online interactive database 51 within the OncoBoard platform 55 where they are centrally stored. When these RTD files 5 are received by the planning company 50, they are further processed by the planning company 50, and the GTV contours defined by the radiation physician 30 are excluded (“turned off”) from view. This adjusted RTD file 6, without the GTV contours, is forwarded for direct review by the diagnosing physician 10 who then makes a completely independent determination of what he/she believes the target area(s)/GTV to be, defining 12 them and their contours, thereby creating a second, unique version of radiation treatment data (RTD) files 8. This new RTD file 8 is then sent back to the planning company 50 for placement upon the OncoBoard 55's online database 51.

In conjunction with the planning company 50, the GTV contours contained within the RTD files 5 previously created by the radiation physician 30 are then accessed (“turned back on”) and overlaid with those RTD files 8 defined by the diagnosing physician 10. If these RTD files/GTV contours 5 and 8 match perfectly, the diagnosing physician 30 signs off on these matched GTV contours, now comprising a “composite” RTD/GTV file 56. This file is then submitted for physics and computer calculations 57 using a separate calculation computer and leading to completion of the Radiation Treatment Plan (RTP) 9. Conversely, if significant differences exist in the independently defined RTD files/GTV contours 5 and 8, the radiation physician 30 will be contacted. Using the online OncoBoard platform 55, the planning company 50 will facilitate a collaborative effort, including the exchange of RTD drafts 7 and 8, between the diagnosing 10 and radiation 30 physician to resolve differences and possible conflicts, producing a mutually agreed upon GTV and “composite” RTD/GTV file 56. This is then, as above, submitted for physics and computer calculations 57. In either scenario, the RTP 9 ultimately created will be the culmination of a cooperative effort between physicians from different medical disciplines through the iterative exchange of opinions and comments.

In this embodiment, the RTD files 5 from the radiation physician 30, the adjusted RTD files 6, the shared RTP draft files 7 and 8, the Composite RTD/GTV file, and the final RTP file 9 are all in digital media format. These files, as well as the online database 51 are all encrypted using industry and government standard encryption technologies; in some embodiments, Secure Socket Layer (SSL) for transmissions and Advanced Encryption System (AES) for data storage. User authentication is also in compliance with industry and government standards, in some embodiments using multi-factor and token authentication systems.

The functionality of the OncoBoard Online system 55 enables online collaboration, for example, the iterative process of creating of the final RTP 9. Discussions and the exchange of draft proposals 7 and 8 can be accomplished online as well as, the more traditional modes of offline, and via face-to-face meetings.

In reference to FIG. 2, an additional embodiment of the system is possible in which the planning company 50's online interactive OncoBoard database 51 and OncoBoard online interactive collaboration module 55 are accessed through the Internet.

In reference to FIG. 2, an additional embodiment of the system is possible in which the planning company 50's online interactive OncoBoard database 51 and OncoBoard online interactive collaboration module 55 are access through a private network, such as a Virtual Private Network (VPN) or Intranet.

In reference to FIG. 2, an additional embodiment of the system is possible in which the diagnosing physician 10's and the radiation physician 30's computers are PCs and their interfaces with the planning company 50's online services, the OncoBoard online database 51 and OncoBoard online collaboration module 55, are via web browsers (such as Microsoft Internet Explorer, Safari, Firefox, Opera, and so on).

In reference to FIG. 2, an embodiment of the system in which the OncoBoard online collaboration module 55 and the OncoBoard online database 51 are implemented as part of a cloud computing environment.

In reference to FIG. 2, an embodiment of the system in which the OncoBoard online database 51 is implemented as a relational database, using relational database software (such as Oracle, MySQL, and SQL Server).

What is claimed is:

1. A treatment collaboration method comprising:
A. A coordinating entity obtaining at least a portion of the information relevant to patient treatment from at least one medical care provider;
B. The coordinating entity sharing at least a portion of the treatment information with at least one additional care provider and also obtaining treatment information from that care provider;
C. The generation of a patient treatment plan that is mutually agreed upon by the participating care providers;
D. The distribution by the coordinating entity of the mutually agreed upon patient treatment plan to at least one of the participating care providers;

2. The collaboration method of claim 1 wherein the coordinating entity is responsible for the generation of the mutually agreed upon patient treatment plan;

3. The collaboration method of claim 1 wherein the coordinating entity stores at least a portion of the treatment information and manages at least a portion of the process of reaching a consensus as to the patient treatment plan;

4. The collaboration method of claim 3 wherein at least one care provider's proposed treatment specifications are not initially shared with at least one other care provider, until after the receipt by the coordinating entity, of a proposed treatment specification from at least on other care provider;

5. The collaboration method of claim 1 wherein one care provider is a radiation physician, an additional care provider is a diagnosing physician, and the coordinating entity is a planning company;

6. The collaboration method of claim 1 wherein at least one of the patient information files is a digital file; one that is capable of being generated, stored and transmitted via digital media processors and transmitters;

7. The collaboration method of claim 3 wherein at least one communications medium used for the mediation and consensus interactions is a digital communication medium;

8. The collaboration method of claim 7 wherein the digital collaboration medium, may include, but is not limited to, one of: online conference services, the Internet and cloud computing;

9. The collaboration method of claim 6 wherein at least one digital file is encrypted;

10. The collaboration method of claim 7 wherein at least one digital communications medium is encrypted.
